(19) United States
(12) Patent Application Publication
(10) Pub. No.: US 2026/0151843 A1
(43) Pub. Date: Jun. 4, 2026

(54) WAVEFORM REGULATION IN CONTROLLED SHORT ARC GAS METAL ARC WELDING

(71) Applicant: The ESAB Group, Inc., North Bethesda, MD (US)

(72) Inventor: Per Aberg, Laxa (SE)

(21) Appl. No.: 19/456,006

(22) Filed: Jan. 22, 2026

Related U.S. Application Data
(63) Continuation of application No. PCT/US2024/039079, filed on Jul. 23, 2024.
(60) Provisional application No. 63/515,145, filed on Jul. 24, 2023.

(51) Int. Cl. B23K 9/067; B23K 9/095

(52) U.S. Cl. CPC B23K 9/067; B23K 9/095

(57) ABSTRACT

Systems and methods for operating a welding power supply are disclosed. A method may include operating the welding power supply during a short arc welding process having repetitive cycles each including a short circuit phase and an arc phase, during the short circuit phase, causing a fast ramp up of current from a background current level to a predetermined current level, and upon reaching the predetermined current level, slowing the fast ramp up of the current to a relatively slower ramp up of current until the arc phase begins, wherein the predetermined current level is set based on a percentage of a current level detected at a transition between the short circuit phase and the arc phase in at least one prior cycle.

### RELATED APPLICATIONS

This application claims priority to and the benefit of International Patent Application No. PCT/US2024/039079, entitled “WAVEFORM REGULATION IN CONTROLLED SHORT ARC GAS METAL ARC WELDING,” filed Jul. 23, 2024, which claims priority to U.S. Provisional Patent Application No. 63/515,145 , entitled “WAVEFORM REGULATION IN CONTROLLED SHORT ARC GAS METAL ARC WELDING,” filed Jul. 24, 2023, the entire disclosures of which are hereby incorporated by reference in their entirety for all purposes.

### TECHNICAL FIELD

The present disclosure relates to regulating waveform characteristics in controlled short-arc gas metal arc welding (GMAW).

### BACKGROUND

Controlled short arc metal arc welding (GMAW), including short arc metal inert gas (MIG) and short-arc metal active gas (MAG) welding, is a commonly used welding process that provides lower energy (lower heat) in the welding process, which is generally suitable for use with thin materials such as sheet metal and filling of large root openings while achieving high weld travel speeds and deposition rates. GMAW involves forming an electric arc between a consumable wire electrode, advanced by a wire feeder, and a workpiece on which melted welding material from the wire electrode is deposited. Controlled short arc welding is one type of GMAW in which a periodic cycle is used to transfer individual droplets of the weld material from the melting electrode onto the workpiece, typically between 20 to 200 cycles per second.

### BRIEF DESCRIPTION OF THE DRAWINGS

FIG. 1 is an illustration of an example welding system in which embodiments directed to regulation of a controlled short arc GMAW waveform may be implemented.

FIG. 2 is a block diagram of an example power supply and an example power supply controller (PSC) of the welding system of FIG. 1.

FIG. 3 is a graph illustrating both the current and voltage waveforms for one cycle of a short arc GMAW process.

FIG. 4 is a flowchart depicting a series of steps for operating a welding power supply according to an example embodiment.

FIG. 5 is a flowchart depicting a series of steps for operating a welding power supply according to another example embodiment.

FIG. 6 is a flowchart depicting a series of steps for operating a welding power supply according to still another example embodiment.

### DETAILED DESCRIPTION

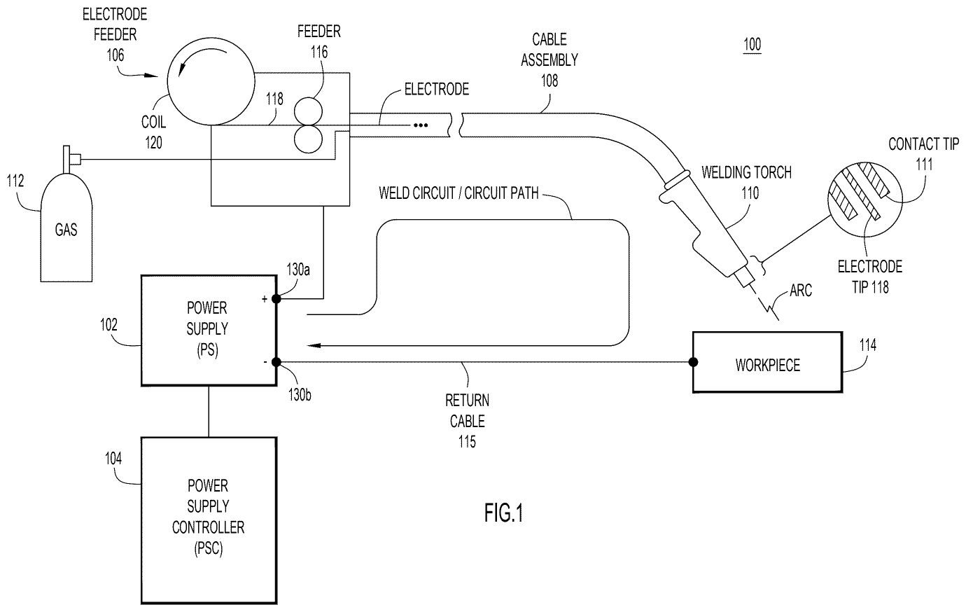

With reference to FIG. 1, there is an illustration of an example GMAW (e.g., MIG/MAG) welding system 100, in which waveform regulation in a controlled short arc GMAW process may be implemented according to the described concepts. In the example shown in FIG. 1, welding system 100 includes: a power supply 102; a power supply controller (PSC) 104 coupled to and configured to control the power supply 102; a wire electrode feeder 106 coupled to the power supply 102; a cable assembly 108 coupled to the wire electrode feeder 106; a torch 110 coupled to the cable assembly 108 and having a sturdy metal contact tip 111 that extends from an end of the torch 110; a gas container 112 coupled to the cable assembly 108; and a workpiece 114 coupled to the power supply 102 through at least a return path/cable 115. While FIG. 1 shows a manual (hand-held) welding torch, it will be understood that the described techniques can be applied in an automated welding system as well. In the ensuing description, the terms “weld” and “welding” are synonymous and interchangeable. In the context of arc welding, torch 110 may be referred to as a “welding torch” or “welding gun.”

Wire electrode feeder 106 includes a feeder 116 to feed a consumable electrode from a coiled wire electrode 120 through cable assembly 108 and through contact tip 111 of torch 110, which is in electrical contact with the electrode. Under control of PSC 104, power supply 102 generates weld power that drives the welding process/operation. In welding operations that involve a pulsed or periodic waveform, the weld power typically includes a series of weld current cycles, which in a controlled short arc GMAW process may include between 20 to 200 cycles per second. Power supply 102 provides the weld power from an output terminal 130a of the power supply to the wire electrode, through feeder 116, cable assembly 108, and torch 110, while the cable assembly 108 also delivers a shielding gas from gas container 112 to the torch. Return path/cable 115 provides an electrical return path from workpiece 114 to an input terminal 130b of power supply 102. The aforementioned components comprise a circuit path or weld circuit from output terminal 130a to input terminal 130b of power supply 102, through wire electrode feeder 106, cable assembly 108, torch 110, workpiece 114, and return path/cable 115.

During a welding operation, an electrode tip 118 of the electrode is brought into contact or near contact with workpiece 114, and the weld power (i.e., current and voltage) supplied by power supply 102 to the torch 110 creates an arc between workpiece 114 and electrode tip 118 extending through the contact tip 111. To control the welding process, PSC 104 controls power supply 102 to generate the weld power (e.g., current and voltage) at a desired level for the welding process, based on feedback in the form of measurements of the current and voltage (e.g., arc voltage) supplied by the power supply 102 to the welding process. The measurements may be produced by current and voltage sense points in power supply 102 and/or at sense points that are remote from the power supply 102, such as in cable assembly 108 or torch 110. When welding system 100 is operated in a short arc GMAW mode, power supply 102 supplies to the torch 110 a current waveform that periodically fluctuates according to the waveform characteristic described herein.

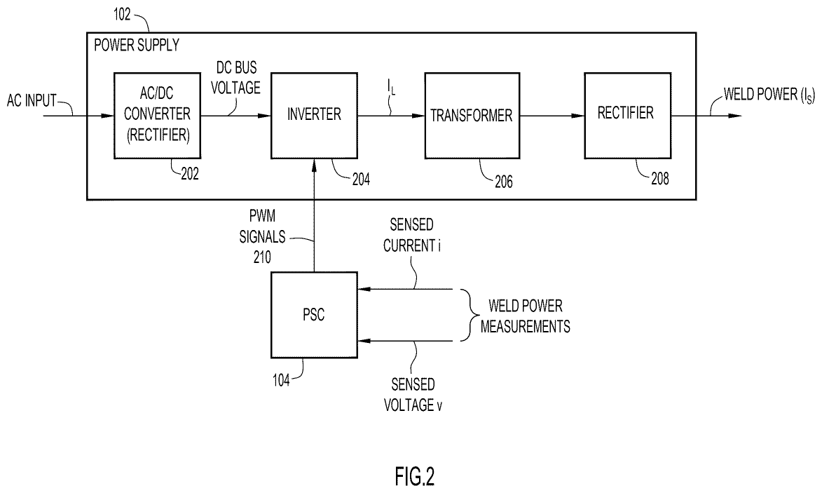

FIG. 2 is a block diagram of an example power supply 102 with PSC 104, according to an embodiment. Power supply 102 includes an AC/DC converter 202 to receive AC input power (e.g., from AC mains or a generator), a power inverter (referred to simply as an “inverter”) 204, a high-frequency transformer 206, and a rectifier 208 coupled to one another. AC/DC converter 202 includes, for example, a diode rectifier to convert the AC input power to a constant, rectified DC voltage (also referred to as a DC “bus” voltage), and provides the DC bus voltage to an input of inverter 204. Under control of PSC 104, inverter 204, transformer 206, and rectifier 208 collectively operate as a weld process regulator to convert the DC bus voltage to a desired weld power supplied by power supply 102 for a welding operation.

Inverter 204 comprises a set of high-speed semiconductor switching devices (i.e., power switches) that are pulse width modulated (i.e., switched on and off at a switching frequency) responsive to pulse width modulation (PWM) waveforms 210 (also referred to as “PWM signals”), generated by PSC 104 and applied to control terminals of the switching devices, to convert the DC bus voltage to an AC (power) signal or waveform including a voltage and a primary current I_{L} that flows into transformer 206. Such operation is referred to as “PWM operation” of inverter 204. Inverter 204 may include a four-quadrant inverter, such as an H-bridge inverter, for example. In other examples, other types of inverters may be employed. Example switching frequencies may be in a range from 1 kHz- 100 kHz, although other switching frequencies above and below this range may be used. Inverter 204 supplies the AC signal to transformer 206. Transformer 206 converts the voltage and current of the AC signal from inverter 204 to a transformed AC signal having desired levels of a voltage and a secondary current I_{S} for the welding operation, and supplies the transformed AC signal to rectifier 208. Rectifier 208 rectifies the transformed AC signal to produce the weld power and supplies the same to the welding process.

Welding system 100 includes a current sense point to provide a sensed or measured current i to PSC 104. Current i is indicative of the weld current supplied to weld torch 110 during a weld operation and when welding system 100 is idle and not actively engaged in the welding operation. Welding system 100 includes a voltage sense point to provide a sensed or measured voltage v to PSC 104. Voltage v is indicative of the weld voltage supplied to weld torch 110 during a weld operation and when power supply is welding system 100 is idle and not actively engaged in the welding operation. The current and voltage sense points may be located in or near the sequential stages of power supply 102, or may be implemented remotely from the power supply 102. Together, current i and voltage v represent measurements of weld power supplied by power supply 102 to torch 110 for a welding process. That is, together, current i and voltage v represent weld power measurements. To control the weld power generated by power supply 102, PSC 104 generates and controls (e.g., dynamically adjusts) PWM waveforms 210 applied to inverter 204 based at least in part on the weld power measurements. For example, PSC 104 may increase duty cycles and thus on-times of PWM waveforms 210 applied to inverter 204 to increase the weld power, and vice versa. In this way, power supply 102 and PSC 104 implement a feedback control loop to control PWM waveforms 210 based on current i and voltage v.

The described technique enables regulating dynamic characteristics of an electric arc in short arc gas metal arc welding and can be implemented in a welding power source such as that shown in FIGS. 1 and 2, for example, to enable a user to control the output of the weld process and to benefit in terms of optimizing welding performance quality in conjunction with a specific welding application having particular quality requirements on the weldment.

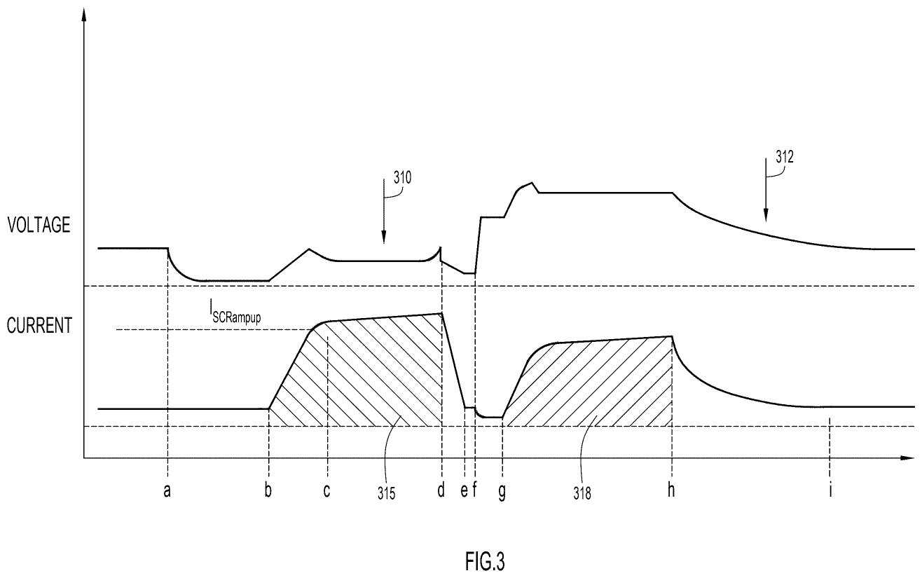

FIG. 3 illustrates a timing diagram of one cycle of a controlled short arc cycle showing both the current waveform and the voltage waveform. According to the described implementation, each droplet cycle begins by forming a short circuit between the wire electrode and the workpiece. That is, the tip of the electrode is directly touching the weld pool on the workpiece and there is no arc between the tip of the electrode and the workpiece. After short circuit detection, a wetting time begins at time “a” and extends to time “b” to assure good wetting of the droplet to be transferred. From time “b” to about time “c” the current supplied via the electrode is rapidly ramped up from a low, background level to a high level. The concept behind increasing the current during the short circuit condition is that the current heats the wire electrode and causes a molten droplet to form at the tip of the electrode, which will ultimately “pinch off” and separate from the electrode. At time “c” droplet pinch off detection is engaged.

After the current reaches a certain short circuit current level, I_{SCRampup}, a little before time “c” in the diagram of FIG. 3, the system transitions to controlling the current level via a voltage control (CV) loop, which results in a smooth current ramp that gradually increases until the system detects that the droplet is pinching off at time “d.” The CV control causes the voltage to settle to a substantially constant voltage prior to the droplet pinch off and leads to a smooth current ramp due to a stable error value during the short circuit. The CV control can be implemented with a PID (proportional, integral, derivative) controller or a PI (proportional, integral) controller, for example. Any of a variety of techniques can be used to detect the onset or occurrence of the droplet pinch off. For example, the droplet pinch off can be detected from a sudden rise in the voltage as the short circuit condition ends with the droplet separation. According to one approach, the welding power source can monitor the time derivative of the voltage, du/dt, and use the event of du/dt exceeding a threshold value as the criterion for determining that pinch off is occurring. Once pinch off is detected, CV control is stopped and various mechanisms can be used to rapidly reduce the current upon detection of the onset of pinch off in order to control the droplet transfer and reduce spatter. This rapid current reduction can be seen between time “d” and time “e.” For example, various “current brake” mechanisms can be implemented in the welding power source hardware, software, or a combination thereof so that current is substantially reduced just before the droplet pinches off. At time “e,” the current reduction flattens out, and ordinary current control of the current waveform resumes.

The period from time “b” to time “d” can be considered the short circuit phase current pulse period. Notably, during this portion of the short circuit phase of the short arc cycle, the system attempts to keep the output voltage at a certain constant level as suggested by the flat profile of the voltage waveform until just before pinch off, as indicated by arrow 310 pointing to this profile in the diagram. Thus, the portion of the short circuit phase between just before time “c” through time “d” can be considered the CV-regulated portion of the short circuit current pulse.

Once the short circuit is broken, an arc forms between the electrode tip and the workpiece, as signified by the rapid rise in voltage at time “f,” and the arc phase of the cycle begins. During this initial portion of the arc phase, a CC control loop can be employed. The arc phase of the cycle includes a high current period followed by a low current period, which eventually leads into the next droplet cycle and short circuit period. More specifically, the arc phase includes another current pulse, beginning at time “g” and ending at time “h,” which is designed to achieve a desired behavior in the weld pool which, during the arc phase of the cycle, is coupled to the wire electrode via an electric arc. During this arc phase current pulse period, the current can again be controlled by a CV control loop.

The arc phase current pulse period is followed by a second arc phase “tail” period in which the current is reduced. During this arc phase tail period, CV control is again employed. The CV regulator uses a relatively large slope in its static characteristic (low gain) that causes the relatively high current at time “h” to decay asymptotically towards a lower, background value at time “i.” Proper control of this tail period in relation to the rest of the short arc current and voltage waveforms is essential to keep the duration of the droplet cycles fairly constant over time. Since the square of the current level is proportional to the heat energy being applied to the electrode, if the current level drops too quickly, a longer time is required to apply the required amount of heat energy and the duration of the droplet cycle increases. Conversely, if the current level is reduced too gradually, the heat energy builds up faster, resulting in a shorter droplet cycle. Overall, employing the arc phase current pulse allows most of the heat energy to be transferred during the current pulse, and having less of the heat energy (lower current levels) in the tail and a more predictable current waveform profile enable better control over the timing of droplet transfer and keeping the droplet cycle period more consistent throughout the weld process, thereby yielding better consistency in pulse frequency. The arc phase “tail” period continues until the beginning of a new short circuit wetting period.

According to one aspect of the described implementation, the technique for regulating the controlled short arc waveform involves controlling the fast ramp of the current during the short circuit period, from the end of the wetting period at time “b” to a point in time when the current reaches a target level, which is a short time before time “c” in FIG. 3, based on the observed current level at the time of pinch off (i.e., at time “d”) from previous droplet cycles. More specifically, during the fast ramp period, the system causes the current to rapidly increase from a low, background current level to an upslope end current value of I_{SCRampup}. Once the current level reaches the upslope end current value, the system terminates the fast ramping process and transitions to CV control until pinch off is achieved at time “d.” Thus, the trigger for transitioning from the fast ramp period to the slower ramping CV control period is the current reaching the upslope end current value I_{SCRampup}.

Importantly, the upslope end current value varies over time, e.g., from cycle to cycle and is set as a percentage or fraction of the pinch off current level from previous droplet cycles. For example, the upslope end current value can be set to be 80% of the pinch off current level from the previous droplet cycle. According to one option, the upslope end current value computed for each cycle is based on the pinch off current level from several previous cycles. For example, the upslope end current value can be computed as 80% of the average of the pinch off current level from the last n droplet cycles. According to another option, the upslope end current value can be computed based on a pinch off current level value determined by low pass filtering a time sequence of pinch off current levels or a time fading average. In summary, this aspect of the described implementation involves transitioning from a fast current ramp period to a more gradual current increase period during a short circuit welding condition based on the current reaching a threshold value, where that threshold value is set as a function of the pinch off current level observed from previous short arc droplet cycle(s).

Another aspect of the described implementation involves controlling parameters of the arc phase current pulse based on measured characteristics of previous short circuit phase current pulse(s). Specifically, the weld current has some average (mean) value over the short circuit phase current pulse period that can be measured in each cycle, and the amount of energy delivered to the electrode in the short circuit phase current pulse period is proportional to the time integral of the current over this period, i.e., the area under the current curve, indicated by shaded region 315 in the diagram of FIG. 3).

According to this aspect of the described implementation, two parameters of the arc phase current pulse are controlled as a function of measured characteristics of previous short circuit phase current pulses. In particular, the level to which the current is driven in the arc phase current pulse period is set as a function of the average (mean) value of the current over the short circuit phase current pulse period, e.g., the arc phase current level is set as a percentage or fraction of the short circuit average current value by multiplying the short circuit average current value by a scaling factor. According to one option, the average current level is determined in each short circuit current pulse over several short arc droplet cycles, and a filtered average over several cycles is used as the value to set the current level in the arc phase current pulse period, e.g., by low pass filtering a time sequence of short circuit average current values over n droplet cycles or using a time-fading average.

The second parameter of the arc phase current pulse to be controlled is the duration of the current pulse period. As shown in the timing diagram of FIG. 3, the arc phase current pulse is terminated at time “h” and the current level decays to a lower level over the remainder of the arc phase. Specifically, the arc phase current pulse continues until the time integral of the current during the pulse reaches a value that equals a scaling factor multiplied by the time integral of the current during the short circuit current pulse period. In other words, with reference to the diagram, the arc phase current pulse is terminated when the area of shaded region 318 is a certain percentage or fraction of the area of shaded region 315. In this manner the amount of energy applied to the wire electrode during the arc phase current pulse is proportional to the amount of energy applied to the wire electrode during the short circuit phase current pulse. As with the control of the current level, controlling the cut-off time of the arc phase current pulse can be based on a filtered average of the time integral of the current from several previous droplet cycles.

According to yet another aspect of the described implementation, the technique for regulating the controlled short arc waveform involves using the same voltage input (i.e., the voltage to which regulator drives the voltage) for the CV control loop regulator during the arc phase tail period as the voltage input used for the CV control loop regulator during the CV-regulated portion of the short circuit current pulse. That is, the same input voltage is used to drive the CV regulator during the two periods indicated by arrow 310 and arrow 312 in the diagram—between times “c” and “d” and between times “h” and “i.” In many welding operations, the welder sets a nominal operating voltage and expects the welding system to respond and behave in a certain manner at a selected voltage level. Using the same control voltage during these two periods within the short arc cycle promotes the welder's perception that the welding system is indeed responding to the set voltage in the manner expected.

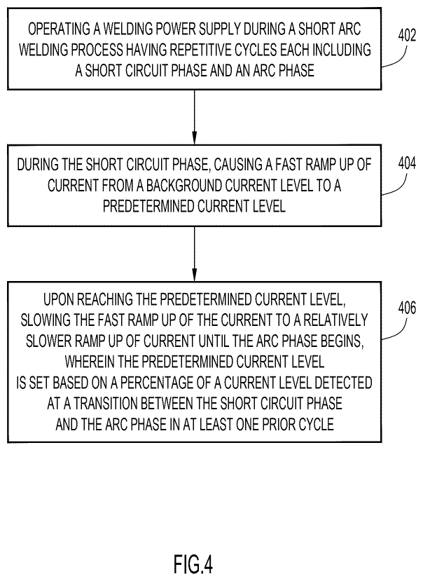

FIG. 4 is a flowchart depicting a series of steps for operating a welding power supply according to an example embodiment. At 402, an operation includes operating the welding power supply during a short arc welding process having repetitive cycles each including a short circuit phase and an arc phase. At 404, an operation includes, during the short circuit phase, causing a fast ramp up of current from a background current level to a predetermined current level. And, at 406, upon reaching the predetermined current level, an operation includes slowing the fast ramp up of the current to a relatively slower ramp up of current until the arc phase begins, wherein the predetermined current level is set based on a percentage of a current level detected at a transition between the short circuit phase and the arc phase in at least one prior cycle.

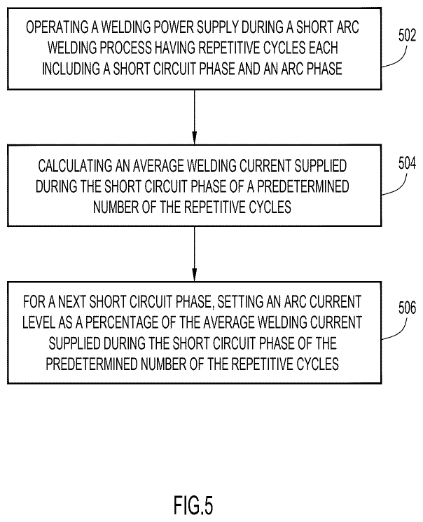

FIG. 5 is a flowchart depicting a series of steps for operating a welding power supply according to another example embodiment. At 502, an operation includes operating the welding power supply during a short arc welding process having repetitive cycles each including a short circuit phase and an arc phase. At 504, an operation includes calculating an average welding current supplied during the short circuit phase of a predetermined number of the repetitive cycles. And, at 506, an operation includes, for a next short circuit phase, setting an arc current level as a percentage of the average welding current supplied during the short circuit phase of the predetermined number of the repetitive cycles.

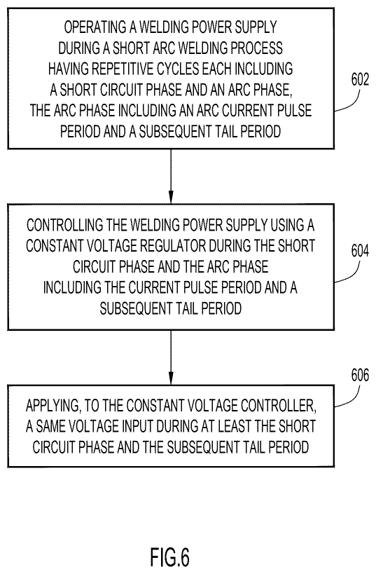

FIG. 6 is a flowchart depicting a series of steps for operating a welding power supply according to still another example embodiment. At 606, an operation includes operating the welding power supply during a short arc welding process having repetitive cycles each including a short circuit phase and an arc phase, the arc phase including an arc current pulse period and a subsequent tail period. At 604, an operation includes controlling the welding power supply using a constant voltage regulator during the short circuit phase and the arc phase including the current pulse period and a subsequent tail period. And, at 606, an operation includes applying, to the constant voltage controller, a same voltage input during at least the short circuit phase and the subsequent tail period.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method of controlling a welding power supply, comprising
operating the welding power supply during a short arc welding process having repetitive cycles each including a short circuit phase and an arc phase;
during the short circuit phase, causing a fast ramp up of current from a background current level to a predetermined current level; and
upon reaching the predetermined current level, slowing the fast ramp up of the current to a relatively slower ramp up of current until the arc phase begins,
wherein the predetermined current level is set based on a percentage of a current level detected at a transition between the short circuit phase and the arc phase in at least one prior cycle.

2. The method of claim 1, wherein the transition between the short circuit phase and the arc phase comprises a pinch off event of a droplet of a consumable electrode.

3. The method of claim 2, wherein the predetermined current level is set based on a percentage of an average of respective current levels detected at transitions between the short circuit phase and the arc phase in multiple prior cycles.

4. The method of claim 1, wherein the percentage is about 80%.

5. The method of claim 1, further comprising employing constant voltage control of the power supply from a first time at which the predetermined current level is detected to a second time at which the transition between the short circuit phase and the arc phase occurs.

6. The method of claim 5, further comprising implementing the constant voltage control with one of a proportional, integral, derivative (PID) controller or a proportional, integral (PI) controller.

7. The method of claim 5, further comprising employing constant current control of the power supply after the transition between the short circuit phase and the arc phase.

8. The method of claim 1, further comprising monitoring welding voltage and welding current during the repetitive cycles of the short arc welding process and supplying corresponding monitored values to the power supply.

9. The method of claim 8, further comprising generating a pulse width modulation signal to control the fast ramp up of current and the slowing the fast ramp up of the current based on the welding voltage and the welding current.

10. A method of controlling a welding power supply, comprising:
operating the welding power supply during a short arc welding process having repetitive cycles each including a short circuit phase and an arc phase;
calculating an average welding current supplied during the short circuit phase of a predetermined number of the repetitive cycles; and
for a next short circuit phase, setting an arc current level as a percentage of the average welding current supplied during the short circuit phase of the predetermined number of the repetitive cycles.

11. The method of claim 10, further comprising calculating the average welding current supplied during the short circuit phase of a predetermined number of the repetitive cycles by filtering a time sequence of short circuit phase current values of the predetermined number of the repetitive cycles.

12. The method of claim 10, further comprising calculating the average welding current supplied during the short circuit phase of a predetermined number of the repetitive cycles using a time-fading average.

13. The method of claim 10, further comprising controlling an end time of the arc phase of a given cycle of the repetitive cycles based on an amount of energy supplied to a consumable electrode during at least one prior short circuit phase.

14. The method of claim 13, further comprising calculating an average amount of energy supplied to a consumable electrode during the short circuit phase of the predetermined number of the repetitive cycles, and controlling the end time of the arc phase of a given cycle of the repetitive cycles based on the average amount of energy.

15. The method of claim 14, further comprising calculating the average amount of energy using a time-fading average.

16. A method of controlling a welding power supply, comprising:
operating the welding power supply during a short arc welding process having repetitive cycles each including a short circuit phase and an arc phase, the arc phase including an arc current pulse period and a subsequent tail period;
controlling the welding power supply using a constant voltage regulator during the short circuit phase and the arc phase including the current pulse period and a subsequent tail period; and
applying, to the constant voltage controller, a same voltage input during at least the short circuit phase and the subsequent tail period.

17. The method of claim 16, further comprising operating the welding power supply using a constant current regulator during a transition period between the short circuit phase and the arc phase.

18. The method of claim 17, wherein the transition between the short circuit phase and the arc phase comprises a pinch off event of a droplet of a consumable electrode.

19. The method of claim 16, further comprising receiving a nominal operating voltage setting for the welding power supply during a short arc welding process.

20. The method of claim 16, further comprising monitoring welding voltage and welding current during the repetitive cycles of the short arc welding process and supplying corresponding monitored values to the power supply
